(19) United States
(12) Patent Application Publication
(10) Pub. No.: US 2024/0190214 A1
(43) Pub. Date: Jun. 13, 2024

(54) VEHICLE HEATING DEVICE

(71) Applicant: Hanon Systems, Daejeon (KR)

(72) Inventors: Dong Hoon OH, Daejeon (KR); Kyung Tae NOH, Daejeon (KR)

(21) Appl. No.: 18/286,413

(22) PCT Filed: May 19, 2022
(86) PCT No.: PCT/KR2022/007163

§ 371 Date: Oct. 11, 2023

(30) Foreign Application Priority Data
May 21, 2021 (KR) 10-2021-0065305
May 13, 2022 (KR) 10-2022-0058885

(51) Int. Cl. B60H 1/22; B60H 1/00; F24H 3/04; F24H 15/128

(52) U.S. Cl. CPC B60H 1/2218; B60H 1/00742; B60H 1/00835; B60H 1/2225; B60H 1/2226; F24H 3/0435; F24H 15/128

(57) ABSTRACT

An embodiment provides a vehicle heating device comprising a heating module which is arranged toward passengers on a flow channel of air, connected to an air conditioning unit, to emit heat, wherein the heating module comprises a heating unit and an overheat protection means for preventing the heating unit from overheating above a predetermined temperature, and the heating unit heats the interior space of a vehicle through at least one of heat convection generated by heating the air and heat radiation obtained by radiating heat directly toward the passengers.

### TECHNICAL FIELD

The embodiment relates to a vehicle heating device. More particularly, the embodiment relates to a vehicle heating device in which an overheat protection means is disposed to prevent overheating of a heat generating unit that heats the interior of a vehicle through heat convection or heat radiation.

### BACKGROUND ART

A vehicle is equipped with an air-conditioning device for a vehicle that serves to adjust an air temperature or the like in a vehicle interior. The air-conditioning device may produce warm air to keep the interior of the vehicle warm in the winter season or produce cold air to keep the interior of the vehicle cool in the summer season.

The air-conditioning device may include an air-conditioning unit configured to supply air with an adjusted temperature to the vehicle interior, and a blower unit configured to supply air to the air-conditioning unit.

The air-conditioning unit may include: an air-conditioning casing having a plurality of discharge ducts; an evaporator disposed in the air-conditioning casing; a heater; and a door configured to adjust an air flow rate. Therefore, the air-conditioning unit may adjust a temperature of the air, which is to be supplied to the interior of the vehicle, by using the evaporator, the heater, and the door. In this case, the heater may be a positive temperature coefficient (PTC) heater using a PTC element.

Further, the blower unit may supply air into the air-conditioning unit by using a blower rotated by an actuator (not illustrated).

Meanwhile, the air-conditioning device may use an infrared lamp to perform local heating and air-conditioning.

As the invention related to the infrared lamp, there is Korean Patent Laid-Open No. 10-2018-0055961 (May 28, 2018) entitled ‘Infrared Ray Heater for Vehicle’.

FIG. 1 is a view illustrating an infrared heater for a vehicle in the related art.

Referring to FIG. 1, the infrared heater may locally heat an interior of the vehicle by using an infrared lamp 1400.

In this case, the infrared heater may include: heat radiating fins 1201 disposed in an air-conditioning duct 1200; reflective plates 1101 configured to reflect heat radiated from the infrared lamp 1400; and heat transfer parts 1103 configured to thermally connect the reflective plates 1101 and the heat radiating fins 1201. Further, the infrared heater may further include barrier films 1303 configured to cover an opening of the reflective plate 1101.

Because the infrared heater uses the infrared lamp 1400, the infrared heater needs to have the reflective plate 1101 and essentially have the heat transfer parts 1103 and the heat radiating fins 1201 to transfer heat to the air-conditioning duct 1200.

However, the configuration including the reflective plate 1101, the heat transfer parts 1103, and the heat radiating fins 1201 increases the size of the infrared heater. Therefore, because the infrared heater with the increased size needs to occupy a part of an interior space of the vehicle, the interior space is reduced, which limits a degree of design freedom of the vehicle.

In addition, the continuous operation of the infrared lamp 1400 may cause the infrared heater to overheat. The overheating may also cause damage to the vehicle.

In addition, the infrared heater may cause a safety issue as there is no safety device for a passenger to access.

### DISCLOSURE

### Technical Problem

The embodiment provides a vehicle heating device in which an overheat protection means is disposed to prevent overheating of a heat generating unit that heats the interior of a vehicle through heat convection or heat radiation.

The embodiment provides a vehicle heating device equipped with a safety device for the safety of a passenger.

Objectives to be solved by the present invention are not limited to the above-described objectives, and other objectives, which are not described above, will be clearly understood by those skilled in the art from the following description.

### Technical Solution

The above problems to be solved may be achieved by a vehicle heating device, which includes: a heat generating module disposed toward a passenger on an air flow channel connected to an air conditioning unit to emit heat, wherein the heat generating module includes a heat generating unit; and an overheat protection means configured to prevent the heat generating unit from overheating to a predetermined temperature or higher, wherein the heat generating unit is configured to heat the interior of the vehicle through at least one of heat convection formed by heating the air and heat radiation obtained by radiating heat directly toward the passenger.

Here, the heat generating unit may be disposed in contact with the overheat protection means, and the overheat protection means is electrically connected in series with the heat generating unit. Alternatively, the vehicle heating device further includes a relay electrically connected to the heat generating unit and the overheat protection means, wherein the relay may cut off power applied to the heat generating unit in conjunction with the temperature of the overheat protection means disposed in contact with the heat generating unit.

Further, the heat generating module may further include a frame configured to support the heat generating unit and the overheat protection means, wherein the heat generating unit may be disposed on the frame, the overheat protection means may be disposed inside the frame, and the heat from the heat generating unit may be transferred to the overheat protection means via the frame.

In addition, the frame may include: an upper plate in which a plurality of holes are formed, a lower plate disposed spaced apart from the upper plate and having a plurality of holes formed therein; and at least one rib disposed between the upper plate and the lower plate, wherein the rib may support the upper plate and the lower plate while guiding air passing through the frame.

Meanwhile, the heat generating unit may include: a planar upper heat generating unit and a planar lower heat generating unit which are disposed in the frame of the heat generating module to be spaced apart from each other so as to form a heat exchange area, wherein the heat emitted from each of the upper heat generating unit and the lower heat generating unit may be heat-exchanged with air passing through the heat generating unit in the heat exchange area.

Here, a plurality of heat exchange areas may be formed, and the heat exchange area includes: a first heat exchange area formed in front of the upper heat generating unit based on the air flow direction; and a second heat exchange area formed between the upper heat generating unit and the lower heat generating unit, wherein the air passing through the hole of the upper heat generating unit may be mixed in the second heat exchange area and simultaneously heat-exchanged with radiant heat of the upper heat generating unit and the lower heat generating unit before passing through the hole of the lower heat generating unit.

Further, each of the upper heat generating unit and the lower heat generating unit may include: a planar body in which a hole is formed, a heat generating part disposed on the body; and a first electrode and a second electrode disposed on the body to apply power to the heat generating part, wherein the heat generating part of the lower heat generating unit may be disposed to be overlapped with the hole of the upper heat generating unit based on the air flow direction.

In addition, the upper heat generating unit and the lower heat generating unit may be selectively applied with power by a controller.

Meanwhile, the vehicle heating device may further includes a housing rotatably connected to a discharge duct of the air conditioning unit, wherein the heat generating module may be disposed inside the housing.

Here, the housing may include: a duct unit connected in communication with the discharge duct; and a guide configured to guide air introduced into the duct unit to the heat generating module, wherein the guide may include: a body in which a first guide hole and a second guide hole having different sizes are formed; and a guide projection formed to protrude from the body to guide air discharged through the first guide holes, and wherein the second guide hole may be disposed closer to the air conditioning case of the air conditioning unit than the first guide hole.

Further, the vehicle heating device may further include a sensor configured to detect that a part of the passenger's body approaches the heat generating module.

Furthermore, the vehicle heating device may further include a door that is disposed inside the floor duct of the air conditioning unit, wherein the door may be configured to adjust the amount of air moving along the floor duct. Herein, the housing further may include a heating part disposed on an inner surface of the duct unit, wherein the heating part may be configured to heat the air moving along the inside of the duct unit.

In addition, the air conditioning unit may include a heat exchanger disposed therein, wherein the air supplied to the air conditioning unit and passing through the heat exchanger may be moved to the air flow channel.

Meanwhile, the vehicle heating device may further includes: a housing accommodating the heat generating module therein and communicating with one side of the air conditioning unit; and a support member configured to support the heat generating module so that the heat generating module is disposed in the housing, wherein the heat generating module may include a frame in which the heat generating unit is disposed, and the overheat protection means may be in close contact with the heat generating unit through hook coupling with the frame.

Here, the overheat protection means may include: a heat generating element; a case configured to tightly fix the heat generating element to the heat generating unit through hook coupling; and a wiring connected to one side of the heat generating element, wherein a hook of the case may be inserted into the hole of the frame.

Preferably, the support member may include: a connector part formed for coupling with an external power source; and a power terminal disposed adjacent to the connector part, wherein the hook may be coupled to a hole closest to the power terminal among a plurality of holes formed in the frame.

Preferably, the overheat protection means may be disposed adjacent to the power terminal.

Preferably, the overheat protection means may be disposed farther from an inlet of the housing.

Preferably, the case may be formed of a synthetic resin material.

Preferably, the case may include: a case body having a cavity in which the heat generating element is disposed; the hook formed protruding from one side of the case body; and a partition wall disposed in the cavity to support the heat generating element, wherein the partition wall may be disposed to be spaced apart from an inner surface of the case body.

### Advantageous Effects

According to the embodiment, the vehicle heating device may prevent overheating of a heat generating unit that heats the interior of a vehicle through heat convection or heat radiation by using an overheat protection means.

Here, the heat generating unit may improve the heating performance and quality of the passenger by rapidly heating the interior of the vehicle by heating the air supplied from the air conditioning unit or directly heating the passenger by using radiant heat. That is, since the vehicle heating device may selectively control heating by heat convection or heating by heat radiation, heating performance and quality may be improved.

The vehicle heating device may improve safety by using a safety device. Specifically, it is possible to prevent the heat generating unit from directly contacting the passenger by using a cover. In addition, the safety of the passenger may be secured by controlling driving of the heat generating unit using a sensor that detects the approach of a part of the passenger's body within a predetermined distance.

Various useful advantages and effects of the embodiments are not limited to the above-described contents and will be more easily understood from descriptions of the specific embodiments.

### BRIEF DESCRIPTION OF THE DRAWINGS

FIG. 1 is a view showing a conventional infrared heater for a vehicle;

FIG. 2 is a view showing a vehicle heating device connected to a vehicle air conditioning device according to an embodiment;

FIG. 3 is a perspective view showing a vehicle heating device according to an embodiment;

FIG. 4 is a cross-sectional view showing a vehicle heating device according to an embodiment;

FIG. 5A is a view showing that an ankle side of a passenger is heated by a vehicle heating device according to an embodiment;

FIG. 5B is a view showing that a shin side of a passenger is heated by a vehicle heating device according to an embodiment;

FIG. 6 is an exploded perspective view showing a vehicle heating device according to an embodiment;

FIG. 7 is an exploded perspective view showing a heat generating module of a vehicle heating device according to an embodiment;

FIG. 8 is a view showing a planar heat generating unit disposed in a heat generating module of a vehicle heating device according to an embodiment;

FIG. 9 is a view showing an arrangement relationship of a heat generating unit, an overheat protection means, and a frame disposed in a vehicle heating device according to an embodiment;

FIG. 10 is a view showing an electrical connection relationship between a heat generating unit and an overheat protection means disposed in a vehicle heating device according to an embodiment;

FIG. 11 is a graph showing resistance and temperature according to the operation of a heat generating unit and an overheat protection means disposed in a vehicle heating device according to an embodiment;

FIG. 12 is a view showing another embodiment of an electrical connection relationship between a heat generating unit and an overheat protection means disposed in a vehicle heating device according to an embodiment;

FIG. 13 is a graph showing resistance and temperature in another electrical connection relationship between a heat generating unit and an overheat protection means disposed in a vehicle heating device according to an embodiment;

FIG. 14 is a view showing one embodiment of an overheat protection means disposed in a vehicle heating device according to an embodiment;

FIG. 15 is a view showing another embodiment of a frame disposed in a vehicle heating device according to an embodiment;

FIG. 16 is a view showing the flow of air through a housing and a heat generating module of a vehicle heating device according to an embodiment;

FIG. 17 is a view showing heat exchange through a heat generating module of a vehicle heating device according to an embodiment;

FIG. 18 is an exploded perspective view showing a housing of a vehicle heating device according to an embodiment;

FIG. 19 is a view showing a guide disposed in a housing of a vehicle heating device according to an embodiment;

FIG. 20 is a view showing the flow of air guided by the guide of the vehicle heating device according to the embodiment;

FIG. 21 is a view showing an arrangement relationship between a heat generating module and a support member disposed in a vehicle heating device according to an embodiment;

FIG. 22 is a view showing a sensor of a vehicle heating device according to an embodiment;

FIG. 23 is a view showing a heating part of a vehicle heating device according to an embodiment;

FIGS. 24 to 26 are views showing operation control of a vehicle heating device according to an embodiment;

FIG. 27 is an exploded perspective view showing a modified example of an overheat protection means disposed in a vehicle heating device according to an embodiment;

FIG. 28 is a perspective view showing an arrangement relationship of a heat generating module, a modified example of an overheat protection means, a support member, and a cover disposed in a vehicle heating device according to an embodiment;

FIG. 29 is a plan view showing an arrangement relationship of a heat generating module, a modified example of an overheat protection means, a support member, and a cover disposed in a vehicle heating device according to an embodiment;

FIG. 30 is an enlarged view of the overheat protection means shown in FIG. 28;

FIG. 31 is an enlarged view of a cross section of the overheat protection means shown in FIG. 28;

FIG. 32 is a view showing an arrangement relationship of a modified example of an overheat protection means, a heat generating unit, and of a frame of a vehicle heating device according to an embodiment;

FIG. 33 is a view showing a heat generating unit of a vehicle heating device according to an embodiment; and

FIG. 34 is a bottom perspective view showing a modified example of a case of an overheat protection means disposed in a vehicle heating device according to an embodiment.

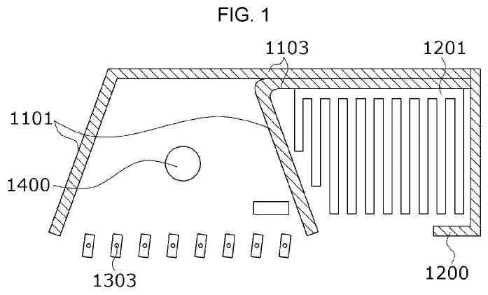

### BEST MODE

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination among a plurality of associated listed items.

When an element is referred to as being “connected” or “coupled” to another element, it will be understood that the element can be directly connected or coupled to another element, or other elements may be present therebetween. In contrast, when an element is referred to as being “directly connected” or “directly coupled” to another element, it will be understood that there are no intervening elements.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, when embodiments are described in detail with reference to the accompanying drawings, components that are the same or correspond to each other will be denoted by the same or corresponding reference numerals in all drawings, and redundant descriptions will be omitted.

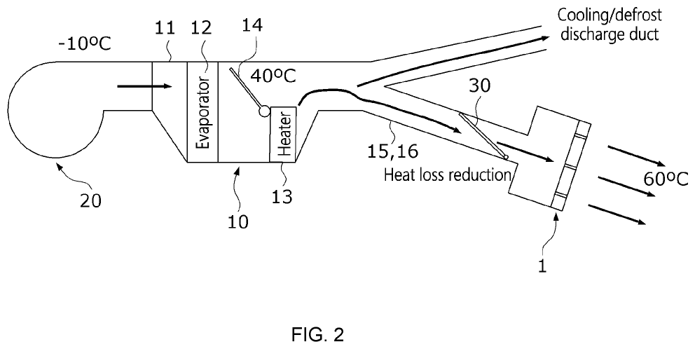

FIG. 2 is a view showing a vehicle heating device connected to a vehicle air conditioning device according to an embodiment, and may be a conceptual diagram illustrating air flow between the vehicle air conditioning device and the vehicle interior.

Referring to FIG. 2, the vehicle heating device 1 according to the embodiment may be connected to one side of an air conditioning unit 10 that supplies air to the vehicle interior to heat the interior of a vehicle through at least one of heat convection and heat radiation. In this case, a blower unit 20 may supply air to the inside of the air conditioning unit 10 by using a blower rotated by an actuator (not shown). In addition, the air conditioning unit 10 may include a heat exchanger for cooling such as an evaporator 12 and a heat exchanger for heating such as the heater 13 disposed therein. Accordingly, the temperature of the air passing through the air conditioning unit 10 may be adjusted.

The vehicle heating device 1 may be a heat generating module provided as a single product, and the heat generating module may be disposed toward a passenger on an air flow channel connected to an air conditioning unit 10 to emit heat. For example, the vehicle heating device 1 may be connected to one side of an air conditioning case 11 of the air conditioning unit 10. Specifically, the vehicle heating device 1 may be connected in communication with a floor duct 15 or a console duct 16 among a plurality of discharge ducts disposed on one side of the air conditioning case 11, and may heat air moving along the floor duct 15 or the console duct 16. Here, the floor duct 15 or the console duct 16 may be provided as the air flow channel connected to the air conditioning case 11. Accordingly, the air supplied to the air conditioning unit 10 and passing through the heat exchanger may be moved to the heat generating module through the air flow channel.

Accordingly, even if the heater 13 disposed inside the air conditioning case 11 heats the air to about 40 degrees, since the vehicle heating device 1 connected to the end of the floor duct 15 or the console duct 16 compensates for the temperature of the air to heat the inside of the vehicle, heat loss through the floor duct 15 or the console duct 16 may be minimized. For example, in a case where the vehicle heating device 1 is not conventionally installed in the floor duct 15 or the console duct 16, the heater 13 disposed inside the air conditioning case 11 heats air to a high temperature of 60 degrees or more and supplies it to the interior of the vehicle, thereby heating the interior of the vehicle. Accordingly, the heat loss occurs through the floor duct 15 or the console duct 16. In this case, the heater 13 may be a positive temperature coefficient (PTC) heater using a PTC element.

Therefore, since the vehicle heating device 1 may directly heat the air flowing through the heat generating module to emit heat and at the same time directly implement heat radiation to the passenger, it is possible to improve the heating performance and heating quality for the passenger, who is the object of heating, and at the same time minimize the heat loss through the ducts.

Here, as an example, the vehicle heating device 1 simultaneously performs heat convection by the blower unit 20 and the heat generating unit, and heat radiation by the heat generating unit, but is not necessarily limited thereto. For example, the vehicle heating device 1 may selectively implement at least one of the heat convection and the heat radiation by a controller (not shown). Here, the controller may be an electronic controller (ECU) of a vehicle.

In addition, a door 30 controlled by the controller may be further disposed in the floor duct 15. Accordingly, the door 30 may adjust or block the amount of air moving along the floor duct 15.

Here, in order to distinguish the door 14 disposed inside the air conditioning case 11 and the door 30 disposed in the floor duct 15, etc., the door 14 disposed inside the air conditioning case 11 may be referred to as a first door, and the door 30 disposed on the floor duct 15 may be referred to as a duct door or a second door. In addition, the door 30 is disposed in the floor duct 15 as an example, but is not necessarily limited thereto. For example, the door 30 may be disposed inside the housing of the vehicle heating device 1.

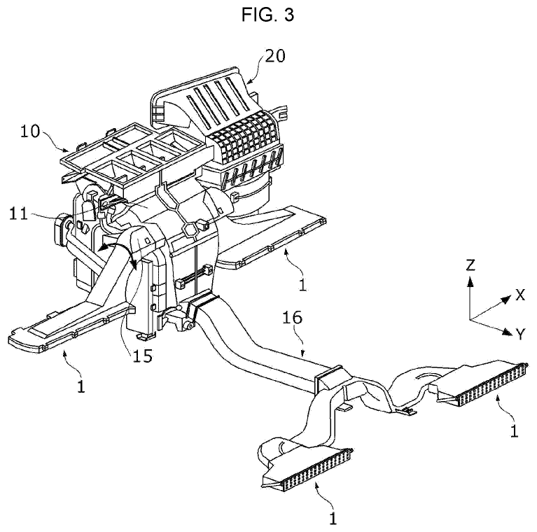

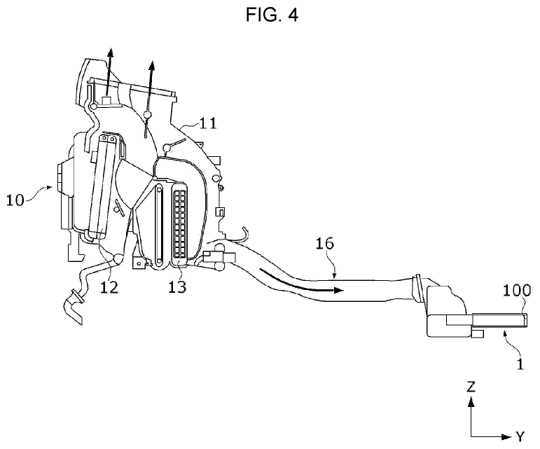

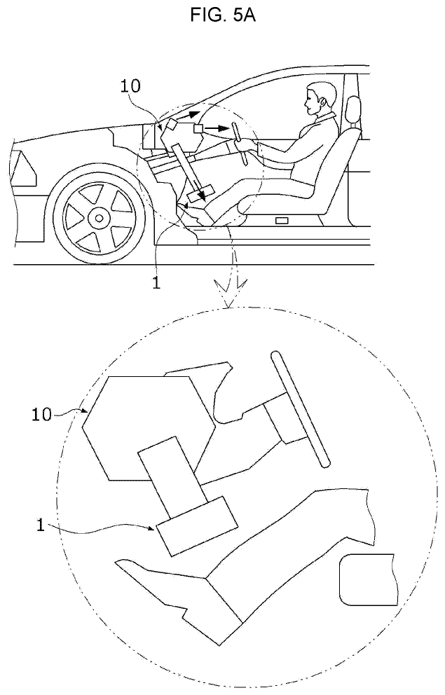

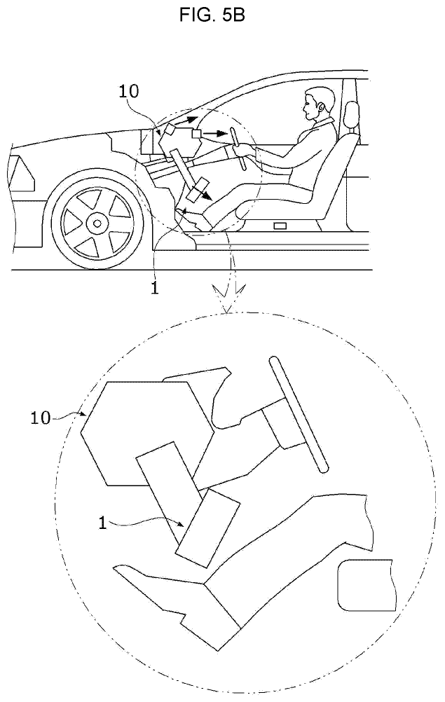

FIG. 3 is a perspective view showing a vehicle heating device according to an embodiment, FIG. 4 is a cross-sectional view showing a vehicle heating device according to an embodiment, FIG. 5A is a view showing that an ankle side of a passenger is heated by a vehicle heating device according to an embodiment, and FIG. 5B is a view showing that a shin side of a passenger is heated by a vehicle heating device according to an embodiment. In FIGS. 3 and 4, the X direction may indicate a vehicle width direction, the Y direction may indicate a front-back direction of the vehicle body, and the Z direction may indicate an up-and-down direction or a vertical direction.

Referring to FIGS. 3 and 4, the vehicle heating device 1 may be disposed on both sides of the air conditioning case 11. For example, at least two vehicle heating devices 1 may be disposed, on both side of the air conditioning case 11 based on the width direction of the vehicle, for each of a driver's seat passenger and an assistant's seat passenger, and may be disposed adjacent to the driver's seat or assistant's seat to be spaced at a predetermined distance from the passenger.

In addition, the vehicle heating device 1 may be disposed on both sides of the console duct 16. Here, the console duct 16 may be one of discharge ducts formed for air conditioning of a passenger sitting in a rear seat of the vehicle.

In addition, the vehicle heating device 1 may be detachably disposed on the floor duct 15 and the console duct 16 to facilitate maintenance.

In addition, the vehicle heating device 1 is rotatably disposed on the floor duct 15 and the console duct 16 so that a heating angle may be adjusted. Accordingly, the vehicle heating device 1 may improve heating performance and quality for passengers.

As shown in FIG. 5A, the vehicle heating device 1 may rotate to heat an ankle side of the passenger. As shown in FIG. 5B, the vehicle heating device 1 may rotate to heat a shin side of the passenger.

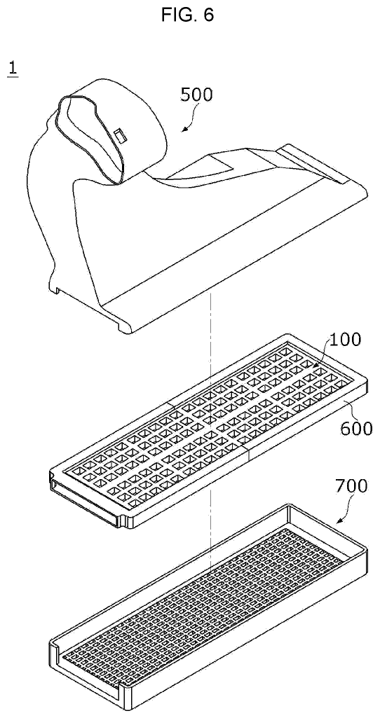

FIG. 6 is an exploded perspective view showing a vehicle heating device according to an embodiment;

Referring to FIG. 6, the vehicle heating device 1 may include a heat generating module 100 disposed toward an passenger on an air flow channel connected to an air conditioning unit 10 to emit heat. Here, the heat generating module 100 may include a heat generating unit 200, an overheat protection means 300 for preventing the heat generating unit 200 from overheating to a predetermined temperature or more, and a frame 400 for supporting the heat generating unit and the overheat protection means 300.

In addition, the vehicle heating device 1 may include a housing 500 in which the heat generating module 100 is disposed. Accordingly, the heat generating module 100 may be accommodated in the inner space of the housing 500. Specifically, the heat generating module 100 may be disposed on an outlet side of the housing 500.

In addition, the vehicle heating device 1 may further include a support member 600 for supporting the heat generating module 100 so that the heat generating module 100 is disposed in the housing 500.

Further, the vehicle heating device 1 may further include safety devices such as a cover 700 and a sensor 800.

Meanwhile, the vehicle heating device 1 may be implemented in a form in which only the heat generating module 100 for emit heat is installed at the end of the floor duct 15 or the console duct 16. Accordingly, the vehicle heating device 1 may implement a compact size to secure an interior space of the vehicle.

Alternatively, in the vehicle heating device 1, the heat generating module 100 may be detachably and rotatably installed at the end of the floor duct 15 or the console duct 16 using the housing 500.

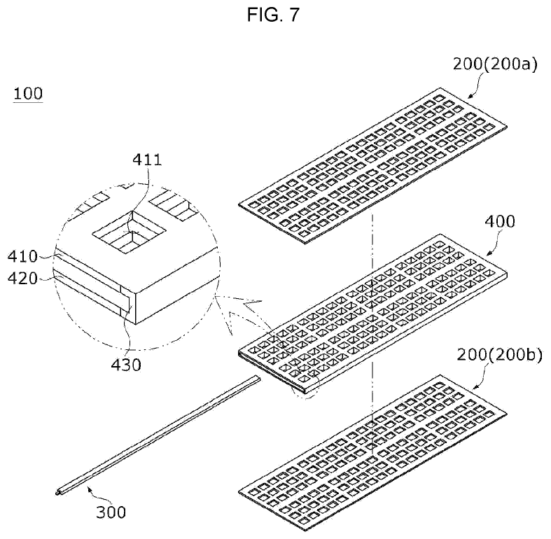

FIG. 7 is an exploded perspective view showing a heat generating module of a vehicle heating device according to an embodiment;

Referring to FIG. 7, the heat generating module 100 may include a heat generating unit 200 to emit heat and an overheat protection means 300 that prevents the heat generating unit 200 from overheating. Here, the heat generating unit 200 may be disposed in contact with the overheat protection means 300, and thus the heat generated in the heat generating unit 200 may be transferred to the overheat protection means 300 through a heat conduction method.

In addition, the heat generating module 100 may include a frame 400 for supporting the heat generating unit 200 and the overheat protection means 300, and the heat formed in the heat generating unit 200 via the frame 400 may be transferred to the overheat protection means 300.

The heat generating unit 200 may minimize the heat loss due to the floor duct 15 and the console duct 16 formed to a predetermined length by raising the temperature of the air heated through the heater 13. For example, since the heater 13 heats the air at about 40 degrees lower than the heating temperature at which the air has been heated in the past, the heat loss due to the floor duct 15 and the console duct 16 may be minimized.

Further, the heat generating unit 200 heats and discharges the air passing through the heat generating unit 200, thereby heating the interior of the vehicle through heat convection.

In addition, the heat generating unit 200 may directly heat the passenger through radiant heat. For example, the heat generating unit 200 may be disposed toward the passenger. Accordingly, the heat generating unit 200 may directly heat the passenger by using heat radiation energy.

In addition, the heat generating unit 200 may be provided as a planar heat generating body that generates heat using electricity. In this case, the heat generating unit 200 may be fixed to the outside of the frame 400 using a fixing member (not shown) such as an adhesive.

Meanwhile, a plurality of heat generating units 200 may be disposed in the frame 400 so as to be spaced apart from each other so as to form a plurality of heat exchange areas. For example, at least two heat generating units 200 may be installed on the frame 400 to be spaced apart at predetermined intervals. Accordingly, a plurality of heat exchange areas in which the heat emitted from the heat generating unit 200 is heat-exchanged with the air may be formed.

As shown in FIG. 7, the heat generating unit 200 may be formed in two layers by being arranged spaced apart from each other in the direction of air flow or in the vertical direction, and may be divided into an upper heat generating unit 200a and a lower heat generating unit 200b depending on the arrangement position. Accordingly, heat emitted from each of the upper heat generating unit 200a and the lower heat generating unit 200b may be heat-exchanged with air passing through the heat generating unit 200 in the heat exchange area. Here, the upper heat generating unit 200a may be referred to as a first heat generating unit, and the lower heat generating unit 200b may be referred to as a second heat generating unit.

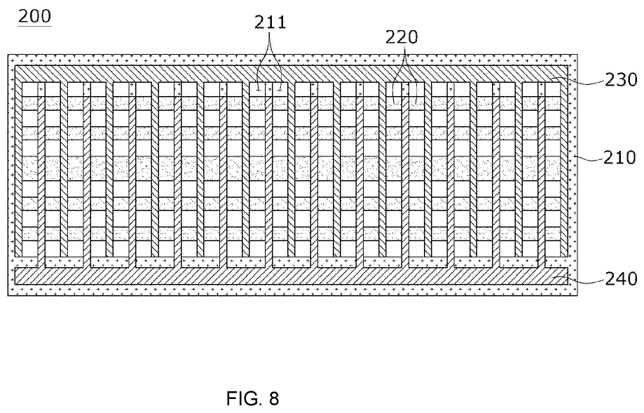

FIG. 8 is a view showing a planar heat generating unit disposed in a heat generating module of a vehicle heating device according to an embodiment.

Referring to FIG. 8, the heat generating unit 200 may include a planar body 210 in which a plurality of holes 211 are formed, a heat generating part 220 mounted on the body 210, and a first electrode 230 and a second electrode 240 disposed on the body 210 to apply power to the heat generating part 220.

The body 210 may be formed in a planar shape. For example, the body 210 may be formed in a film shape.

In addition, the body 210 may include a plurality of holes 211 formed to penetrate through it by a blanking molding. Accordingly, the air supplied to the inside of the housing 500 may be guided and discharged through the hole 211. Here, the hole 211 may be formed in various shapes in consideration of the hole structure of the frame 400, air conditioning quality, and the like, and may be called a first hole, a body hole, or a ventilation hole. Also, the body 210 may be called a first body or a heat generating body.

The heat generating part 220 may emit heat by power applied through the first electrode 230 and the second electrode 240. In addition, the heat generating part 220 may be formed in a planar shape. Here, the power may be controlled by the controller.

In addition, the heat generating part 220 may be formed on the body 210 by a printing method using ink such as carbon-based having resistance. Alternatively, the heat generating part 220 may be formed on the body 210 by a method of forming a planar heat generating pattern on a material made of a metal thin film through an etching method. Further, the heat generating part 220 may be formed by a method of disposing a heat generating element such as the PTC element on the body 210. Accordingly, the heat generating part 220 may be called a heat generating pattern or a heat generating element.

In addition, the heat generating part 220 may be disposed adjacent to the hole 211. Here, the adjacency may mean being in contact or being disposed spaced apart at a predetermined interval.

As shown in FIG. 8, the holes 211 may be disposed between the heat generating parts 220. In this case, the hole 211 and the heat generating part 220 may be alternately disposed between the first electrode 230 and the second electrode 240 along one direction. Specifically, for efficient heating of the air, the hole 211 and the heat generating part 220 may be alternately disposed between the first electrode 230 and the second electrode 240 in a first direction. Here, the first direction and the second direction may be defined as directions orthogonal to each other in a plane. In addition, the second direction may be a width direction of the vehicle.

The first electrode 230 and the second electrode 240 may apply power to the heat generating part 220. Here, the first electrode 230 may be a positive electrode, and the second electrode 240 may be a negative electrode.

In addition, the first electrode 230 and the second electrode 240 may be electrically connected to one side and the other side of the heat generating part 220.

Meanwhile, the heat generating unit 200 may be implemented with various shapes by a flexible structure of the body 210, a size, shape, and arrangement position of the hole 211, the heat generating part 220, and the electrodes 223 and 224, respectively. Accordingly, the degree of freedom in designing the heat generating unit 200 may be improved.

The overheat protection means 300 may detect overheating of the heat generating unit 200. Specifically, the overheat protection means 300 may prevent the heat generating unit 200 from overheating to a predetermined temperature or higher. Here, the overheat protection means 300 may detect local or overall overheating of the heat generating unit 200.

The overheating of the heat generating unit 200 may occur when foreign substances are attached to a hole formed in the heat generating module 100 to allow air to pass through and obstruct the flow of air. In addition, the overheating of the heat generating unit 200 may represent when the heat generating unit 200 is heated to a predetermined temperature or higher, such as when the heat generating unit 200 is driven even though the inside of the vehicle heating device 1 is in a windless state.

The overheat protection unit 300 may be arranged in contact with the heat generating unit 200, and thus heat generated in the heat generating unit 200 may be transferred to the overheat protection unit 300 through a heat conduction method.

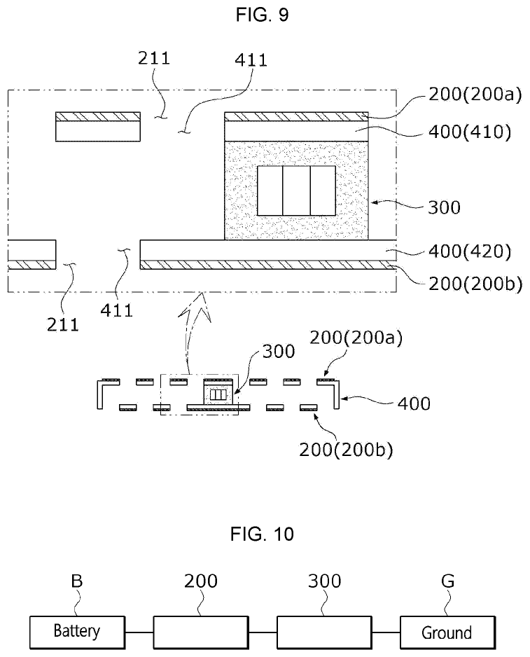

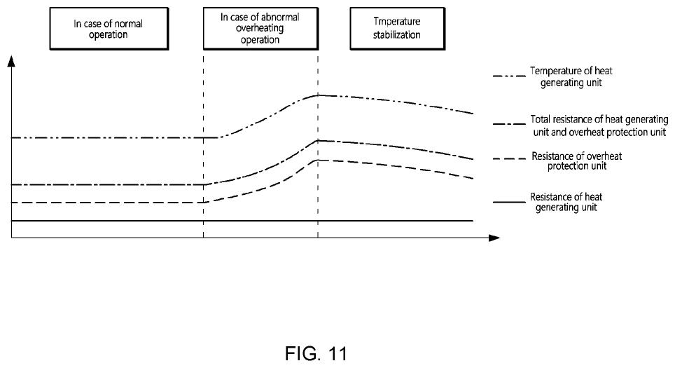

FIG. 9 is a view showing an arrangement relationship of a heat generating unit, an overheat protection means, and a frame disposed in a vehicle heating device according to an embodiment, FIG. 10 is a view showing an electrical connection relationship between a heat generating unit and an overheat protection means disposed in a vehicle heating device according to an embodiment, and FIG. 11 is a graph showing resistance and temperature according to the operation of a heat generating unit and an overheat protection means disposed in a vehicle heating device according to an embodiment.

When the heat generating unit 200 is in an overheated state, the overheat protection means 300 may prevent the heat generating unit 200 from overheating by suppressing the heat generated by the heat generating unit 200.

Referring to FIGS. 9 and 10, the overheat protection means 300 is disposed in contact with the heat generating unit 200 via the frame 400, and is may be electrically connected in series with the heat generating unit 200. Here, as an example, the overheat protection means 300 is in contact with the heat generating unit 200 via the frame 400, but is not necessarily limited thereto. For example, the overheat protection means 300 may be in direct contact with the heat generating unit 200.

When the heat generating unit 200 is in an overheated state, since the overheat protection means 300 is electrically connected in series with the heat generating unit 200, the temperature of the overheat protection means 300 also rises, and thus the current applied to the heat generating unit 200 may be suppressed. Accordingly, the overheat protection means 300 may suppress overheating of the heat generating unit 200 through a structure in which contact and electrical connection are made in series.

The overheat protection means 300 may be a PTC rod using a heat generating element whose resistance increases as the temperature rises. For example, the heat generating element may be a PTC element having the PTC characteristic. Here, the PTC characteristic may have a positive temperature characteristic, and may have a characteristic in which the electrical resistance slightly decreases and then increases as the temperature increases. In particular, since the electrical resistance rapidly rises at a temperature higher than the Curie temperature (inflection temperature), and the current flowing accordingly decreases, it may have a function of suppressing overcurrent. Due to this characteristic, the overheat protection means 300 may suppress overheating of the heat generating unit 200 by using the serial connection of the heat generating unit 200, which has its own temperature stabilization function and has a non-PTC characteristic, and the overheat protection means 300.

Therefore, the overheat protection means 300 may prevent the heat generating unit 200 from overheating while increasing the temperature of the air. That is, the overheat protection means 300 may have both a heating function and an overheating suppression function by using the heat generating element.

Specifically, the heat generating unit 200 and the overheat protection means 300 may be connected in series between a battery B and a ground G. In addition, since the overheat protection means 300 is disposed to be in contact with the heat generating unit 200, the temperature of the overheat protection means 300 also rises due to heat conduction when the heat generating unit 200 is overheated. In this case, since a material having the PTC characteristic may be used for the overheat protection means 300, the resistance of the overheat protection means 300 is increased.

Accordingly, since the resistance of the overheat protection means 300 is increased while the resistance of the heat generating unit 200 is constant, a summed resistance of the overheat protection means 300 and the heat generating unit 200 will be increased. In addition, since the current applied to the heat generating unit 200 is decreased as the summed resistance is increased, the overheat protection means 300 may prevent the heat generating units 200 connected in series from overheating.

Referring to FIG. 11, in case of normal operation, since the temperature of the heat generating unit 200 is constant and accordingly, the resistance of the heat generating unit 200 and the overheat protection means 300 is constant, the total resistance from the battery B to ground G also has a constant value.

In case of abnormal overheating operation of the heat generating unit 200, the resistance of the overheat protection means 300 is increased, resulting in an increase in the total resistance from the battery B to the ground G. Accordingly, since the current flowing from the side of the heat generating unit 200 is suppressed, the increased temperature in the heat generating unit 200 may be suppressed. In addition, as the temperature of the heat generating unit 200 is decreased, the temperature of the overheat protection means 300 is also decreased, so that temperature stabilization may be achieved.

When the heat generating unit 200 is overheated, the overheat protection means 300 may temporarily cut off power applied to the heat generating unit 200 to prevent the heat generating unit 200 from overheating.

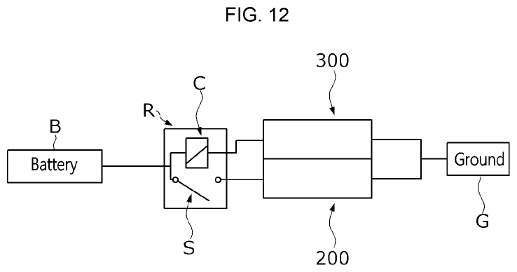

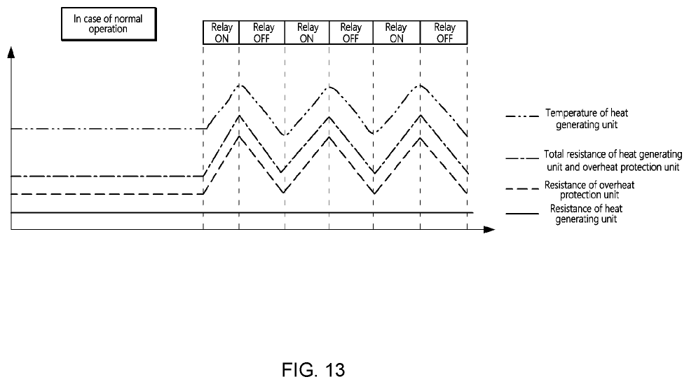

FIG. 12 is a view showing another embodiment of an electrical connection relationship between a heat generating unit and an overheat protection means disposed in a vehicle heating device according to an embodiment, and FIG. 13 is a graph showing resistance and temperature in another electrical connection relationship between a heat generating unit and an overheat protection means disposed in a vehicle heating device according to an embodiment.

Referring to FIGS. 10 and 12, another embodiment of the electrical connection relationship between the heat generating unit 200 and the overheat protection means 300 is different in that a relay R is used, and the heat generating unit 200 and the overheat protection means 300 are connected in parallel between the relay R and the ground G. For example, the other embodiment has the same structure in that it uses the overheat protection means 300 and the frame 400, but differs in that it uses the relay R, and the heat generating unit 200 and the overheat protection means 300 are connected in a parallel structure between the relay R and the ground G. Accordingly, in the other embodiment, the temperature stabilization of the heat generating unit 200 may be implemented more quickly.

When the heat generating unit 200 is overheated, the relay R may cut off the current applied to the heat generating unit 200 in conjunction with the temperature of the overheat protection means 300. For example, the temperature of the overheat protection means 300 rises according to the overheating of the heat generating unit 200, and the relay R blocks the current applied to the heat generating unit 200 due to the rise in temperature. Accordingly, the temperature stabilization of the heat generating unit 200 may be implemented more quickly.

As shown in FIG. 12, the relay R is disposed between the battery B and the ground G, and the heat generating unit 200 and the overheat protection means 300 may be connected in parallel between the relay R and the ground G. In this case, the overheat protection means 300 may be structurally disposed in contact with the heat generating unit 200.

In addition, the relay R may include a coil terminal C and a switch S. Accordingly, the overheat protection means 300 may be connected in series between the coil terminal C and the ground G. In addition, the heat generating unit 200 may be connected in series between the switch S and the ground G.

Therefore, in case of abnormal overheating operation of the heat generating unit 200, the resistance of the overheat protection means 300 rises to limit the current applied to the coil terminal C, so that the current applied to the heat generating unit 200 may be cut off through the switch S. Accordingly, as shown in FIG. 13, the temperature of the heat generating unit 200 may be quickly stabilized in the other embodiment.

At least one of the overheat protection means 300 may be disposed inside the frame 400.

FIG. 14 is a view showing one embodiment of an overheat protection means disposed in a vehicle heating device according to an embodiment.

Referring to FIGS. 9 and 14, the overheat protection means 300 may include a heat generating element 310 having at least one PTC characteristic, an electrode plates 320 and 330 for supplying power to the heat generating element 310, and a tube 340 for accommodating the heat generating element 310 and the electrode plates 320 and 330 therein.

In addition, the overheat protection means 300 may further include a guide plate 350 for guiding the arrangement of the PTC element. Accordingly, the overheat protection means 300 may be provided in a tube shape to secure assembly and durability.

The heat generating element 310 may be disposed between the electrode plates 320 and 330. Further, as power is applied to the electrode plates 320 and 330, the heat generating element 310 may generate heat. In this case, the heat generating element 310 may be connected in series with the heat generating unit 200 via the electrode plates 320 and 330.

The electrode plates 320 and 330 enable power to be applied to the heat generating element 310. Here, the electrode plates 320 and 330 may include a positive electrode plate 320 and a negative electrode plate 330 respectively disposed on both sides of the heat generating element 310.

The tube 340 may be formed in a pipe shape with an accommodation space therein. As shown in FIG. 14, the tube 340 may be formed in a pipe shape having a rectangular cross section. In addition, the tube 340 may be formed of a metal material such as aluminum. Here, the tube 340 may be disposed in direct contact with the heat generating unit 200 or disposed in contact with the heat generating unit 200 via the frame 400.

The guide plate 350 may be formed in a plate shape corresponding to the electrode plates 320 and 330. In addition, the guide plate 350 may include a plurality of holes 351 in which the heat generating elements 310 are disposed.

Meanwhile, since at least one of the overheat protection means 300 may be disposed inside the frame 400 and may use the heat generating element 310, it may also serve as an auxiliary heater for the vehicle heating device 1. For example, a plurality of overheat protection means 300 or a plurality of heat generating elements 310 may be used to serve as an auxiliary heater for the vehicle heating device 1.

The frame 400 may accommodate the overheat protection means 300 therein and may include a plurality of holes 411.

In addition, the frame 400 may be formed of a metal material having thermal conductivity so as to have a close relationship with the temperature of the surroundings in addition to the heat generating unit 200. Accordingly, the frame 400 may easily increase the interior temperature of the vehicle and prevent the heat generating unit 200 from overheating even when at least one overheat protection means 300 is used. The hole 411 may be formed to correspond to the hole 211 of the heat generating unit 200. Accordingly, the air may be supplied to the interior of the vehicle through the hole 411 of the frame 400 and the hole 211 of the heat generating unit 200. Here, the hole 411 formed in the frame 400 may be referred to as a second hole or a frame hole.

Referring to FIG. 7, the frame 400 includes an upper plate 410 in which a plurality of holes 411 are formed, and a lower plate 420 disposed spaced apart from the upper plate 410 and in which a plurality of holes 411 are formed, and a sidewall 430 for connecting an end of the upper plate 410 and an end of the lower plate 420. Here, the upper plate 410, the lower plate 420, and the sidewall 430 may form the outer shape of the frame 400, and may form a space therein. In addition, the space may be provided as a heat exchange area.

The upper plate 410 may be formed in a plate shape having a predetermined thickness. In addition, the upper plate 410 may include a plurality of holes 411 formed to penetrate in the vertical direction for air flow. Here, the hole formed in the upper plate 410 may be referred to as a second upper hole or an upper plate hole.

In addition, different heating qualities may be provided according to the arrangement position of the upper heat generating unit 200a disposed on the upper plate 410.

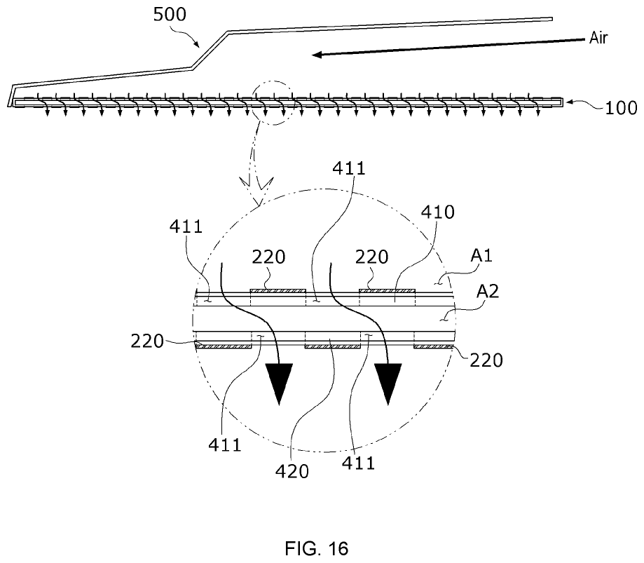

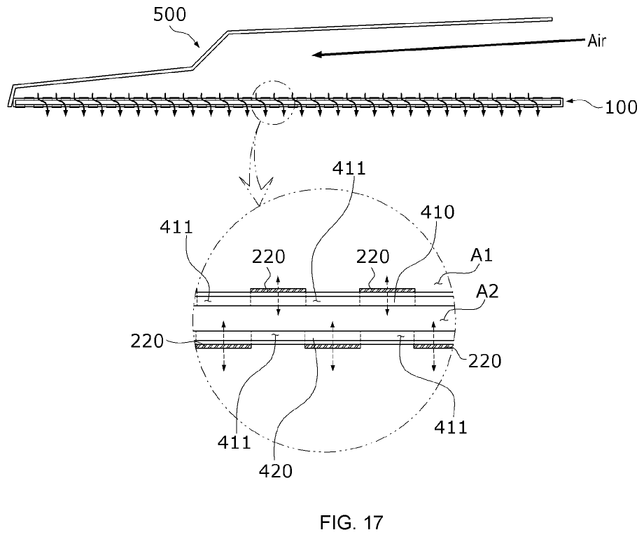

As shown in FIGS. 16 and 17, an upper heat generating unit 200a may be disposed on the upper surface of the upper plate 410 based on the flow of air. For example, considering the heat exchange efficiency with the heat exchange area formed at the front end of the upper heat generating unit 200a based on the flow of air and the increase in the area of the upper heat generating unit 200a, the upper heat generating unit 200a may be disposed on the upper surface of the upper plate 410.

Alternatively, the upper heat generating unit 200a may be disposed on the lower surface of the upper plate 410. In this case, when the heat generating part 220 of the upper heat generating unit 200a is disposed to be overlapped with the hole 211 of the lower heat generating unit 200a, the heat radiation capability of the vehicle heating device 1 is improved.

The lower plate 420 may be formed in a plate shape having a predetermined thickness. In addition, the lower plate 420 may include a plurality of holes 411 formed to penetrate in the vertical direction for air flow. Here, the hole formed in the lower plate 420 may be referred to as a second lower hole or a lower plate hole.

In addition, the lower plate 420 may be formed to be spaced apart from the upper plate 410 at a predetermined interval. Accordingly, a heat exchange area may be formed between the upper plate 410 and the lower plate 420.

In addition, for heat radiation to the passenger, the lower heat generating unit 200b may be disposed on the lower surface of the lower plate 420.

Meanwhile, a protruding pattern such as a projection may be formed in the hole 411 of the lower plate 420. Here, the protruding pattern may increase a residence time of air in a heat exchange area formed between the upper plate 410 and the lower plate 420. Accordingly, heat exchange efficiency in the heat exchange area may be improved.

The sidewall 430 may be disposed between the upper plate 410 and the lower plate 420 to support the upper plate 410 and the lower plate 420. In this case, considering the size of the space formed inside the frame 400, the sidewall 430 may be disposed to connect the end of the upper plate 410 and the end of the lower plate 420.

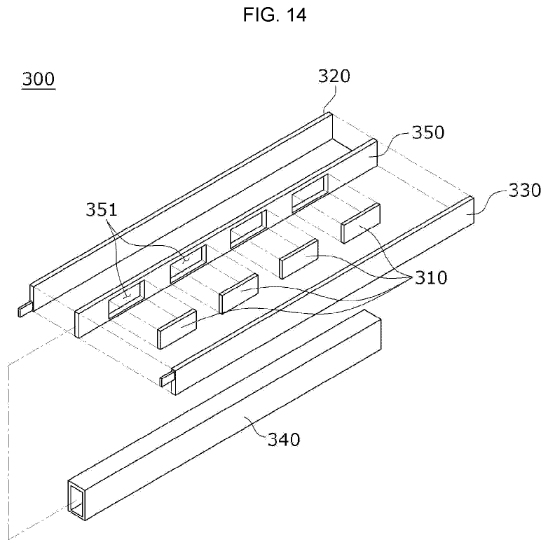

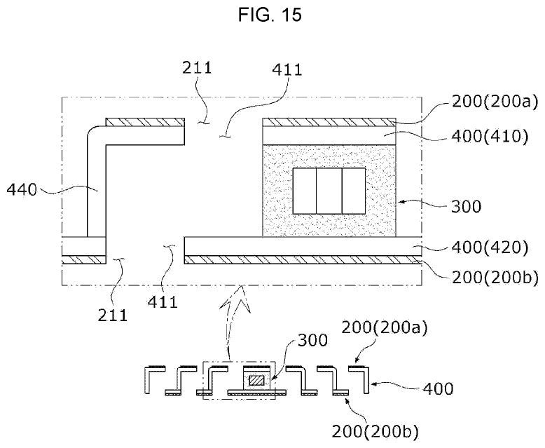

FIG. 15 is a view showing another embodiment of a frame disposed in a vehicle heating device according to an embodiment;

Referring to FIG. 15, the frame 400 may further include at least one rib 440 disposed between the upper plate 410 and the lower plate 420.

The rib 440 may support the upper plate 410 and the lower plate 420. For example, when a load such as an external force is applied to the frame 400, deformation such as pressing may occur in the frame 400. Accordingly, the rib 440 may be used as a support member for preventing the deformation.

In addition, the rib 440 may guide air passing through the frame 400. For example, the rib 440 may guide air introduced into the hole 411 of the upper plate 410 and discharge it through the hole 411 of the lower plate 420. Accordingly, the ribs 440 may implement a uniform flow of the air within the frame 400 or a bias of the air towards a body part that feels a lot of cold air. For this purpose, a plurality of ribs 440 may be disposed within the frame 400.

Meanwhile, the rib 440 may be formed by cutting and then bending a partial area of the upper plate 410. For example, the rib 440 may be formed by a forming method cutting and bending a portion of the upper plate 410.

FIG. 16 is a view showing the flow of air through a housing and a heat generating module of a vehicle heating device according to an embodiment, and FIG. 17 is a view showing heat exchange through a heat generating module of a vehicle heating device according to an embodiment. In FIG. 16, the solid arrows may represent the flow of air. In addition, in FIG. 17, the dashed arrows may represent the emission of heat.

Referring to FIGS. 16 and 17, the heat exchange area may include a first heat exchange area A1 formed at the front end (upstream side) of the upper heat generating unit 200a, and a second heat exchange area A2 formed between the upper heat generating unit 200a and the lower heat generating unit 200b, based on the flow direction of the air formed inside the vehicle heating device 1. Specifically, the second heat exchange area A2 may be formed between the upper plate 410 and the lower plate 420.

The first heat exchange area A1 may be an area in which radiant heat emitted from the heat generating part 220 of the upper heat generating unit 200a and air moving along the duct part 510 of the housing 500 are heat-exchanged. Accordingly, the first heat exchange area A1 may be formed inside the duct part 510 and may be referred to as a preheating area.

The second heat exchange area A2 may be formed between the upper heat generating unit 200a and the lower heat generating unit 200b based on the air flow direction, and may be formed inside the frame 400. In this case, the upper heat generating unit 200a and the lower heat generating unit 200b may be disposed outside the frame 400.

Accordingly, the air flowing between the upper heat generating unit 200a and the lower heat generating unit 200b may be heat-exchanged with radiant heat emitted from each of the heat generating part 220 of the upper heat generating unit 200a and the heat generating part 220 of the lower heat generating unit 200b. Specifically, before passing through the hole 211 of the lower heat generating unit 200b, the air passing through the hole 211 of the upper heat generating unit 200a may be mixed in the second heat exchange area A2 and simultaneously heat-exchanged with heat emitted from each of the upper heat generating unit 200a and the lower heat generating unit 200b.

In addition, the hole 211 of the upper heat generating unit 200a and the hole 211 of the lower heat generating unit 200b are disposed to be crossed with each other based on the air flow direction, so that heating performance may be improved. For example, the hole 211 of the upper heat generating unit 200a and the heat generating part 220 of the lower heat generating unit 200b are arranged to be overlapped in one direction (the air flow direction or the vertical direction) to allow the air passing through the hole 211 of the upper heat generating unit 200a to flow along the heat generating part 220 of the lower heat generating unit 200b, thereby further increasing the residence time of the air in the second heat exchange area A2.

In addition, the heat generating part 220 of the upper heat generating unit 200a is arranged to be overlapped with the hole 211 of the lower heat generating unit 200b in one direction, thereby improving heat radiation performance. Accordingly, the heating efficiency and performance of the vehicle heating device 1 may be improved. In addition, the hole 211 of the upper heat generating unit 200a and the hole 211 of the lower heat generating unit 200b are formed to have different shapes, so that the residence time of the air in the second heat exchange area A2 may be further increased. For example, a retention portion (not shown) such as a projection is formed in the hole 211 of the lower heat generating unit 200b to induce turbulence, so that the residence time of the air in the second heat exchange area A2 may be further increased.

Meanwhile, the heat generating part 220 of the upper heat generating unit 200a and the hole 211 of the lower heat generating unit 200b may be overlapped in one direction (the air flow direction or the vertical direction).

Meanwhile, the upper heat generating unit 200a and the lower heat generating unit 200b may be respectively controlled by the controller. For example, the controller may adjust heating performance by controlling power applied to each of the upper heat generating unit 200a and the lower heat generating unit 200b.

The housing 500 may be connected in communication with the floor duct 15. In this case, one side of the housing 500 may be removably and rotatably disposed on the floor duct 15. Accordingly, the housing 500 may serve as a passageway for the air movement to be transferred from the floor duct 15 to the heat generating module 100.

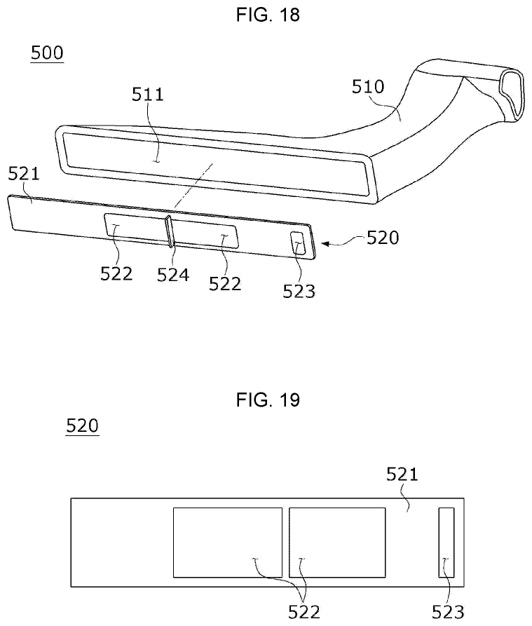

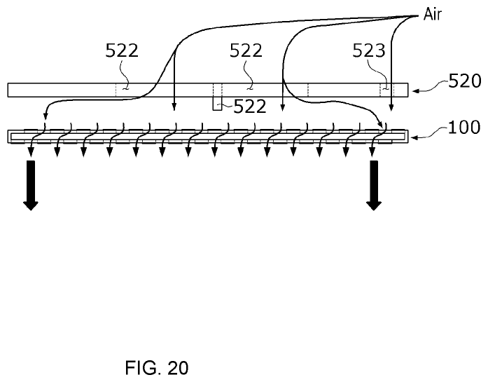

FIG. 18 is an exploded perspective view showing a housing of a vehicle heating device according to an embodiment, FIG. 19 is a view showing a guide disposed in a housing of a vehicle heating device according to an embodiment, and FIG. 20 is a view showing the flow of air guided by the guide of the vehicle heating device according to the embodiment. An arrow shown in FIG. 20 may indicate a flow of air by the vehicle heating device 1, and a thickness of the arrow may indicate a discharge amount of the air.

Referring to FIG. 18, the housing 500 may include a duct part 510 connected in communication with the floor duct 15 and a guide 520 guiding air discharged through the duct part 510. Here, the housing 500 may be formed into various shapes by injection molding a synthetic resin material such as plastic.

The duct part 510 may guide air supplied through the floor duct 15. In addition, one side of the duct part 510 may be disposed in communication with the floor duct 15, and the other side may include an opening 511 formed to discharge air.

The guide 520 may be disposed in the opening 511.

Referring to FIGS. 18 and 19, the guide 520 may include a guide body 521 and a plurality of holes formed through the guide body 521. In addition, the guide 520 may further include a guide projection 524 for guiding the air discharged through the hole.

The guide body 521 may be formed in a plate shape, and may be formed by injection molding a synthetic resin material such as plastic. As shown in FIG. 19, the guide body 521 is formed in a rectangular shape as an example, but is not necessarily limited thereto.

The plurality of holes may be formed in various shapes taking into account the discharge amounts and discharge positions of the air guided through the duct part 510.

The guide projection 524 may be formed to protrude from the guide body 521 in an air discharge direction. For example, the guide projection 524 may be formed to protrude towards the heat generating module 100.

Referring to FIGS. 18 and 19, the plurality of holes may include a first guide hole 522 and a second guide hole 523, and the first guide hole 522 and the second guide hole 523 may be formed in the guide body 521 in different shapes and areas. Accordingly, the air discharged through the first guide hole 522 and the second guide hole 523 may have different discharge positions and different discharge amounts.

For example, the area of the first guide hole 522 may be formed larger than the area of the second guide hole 523, and the second guide hole 523 may be disposed closer to the floor duct 15 or the console duct 16 of the air conditioning case 11 than the first guide hole 522. As shown in FIG. 18, the second guide hole 523 may be disposed farther from the guide projection 524 than the first guide hole 522.

In addition, the two first guide holes 522 formed may be disposed adjacent to each other. In this case, the two first guide holes 522 may be disposed symmetrically with respect to the guide projection 524. That is, the guide projection 524 may be disposed between the two first guide holes 522. Accordingly, the guide projection 524 may guide the air discharged through each of the two first guide holes 522 separately.

Therefore, the housing 500 may improve air conditioning quality for the passenger through the first guide hole 522 and the second guide hole 523 having different areas. As shown in FIG. 20, the air heated by the first guide hole 522, the second guide hole 523, and the guide projection 524 may be directed in a larger amount to the feet, which feel colder than other parts of body. Accordingly, the vehicle heating device 1 may improve the heating quality, such as the passenger's feeling of warmth among air conditioning qualities by the arrangement and shape of the hole.

The support member 600 may be disposed between the housing 500 and the heat generating module 100 to support the heat generating unit 200.

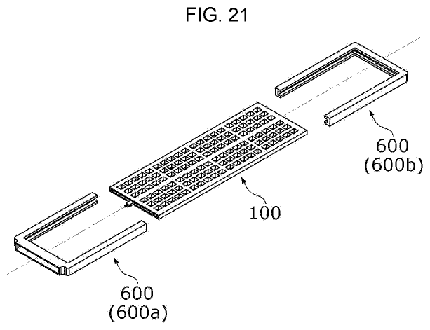

FIG. 21 is a view showing an arrangement relationship between a heat generating module and a support member disposed in a vehicle heating device according to an embodiment.

Referring to FIG. 21, the support member 600 may include a first support member 600a and a second support member 600b, in consideration of the assembly with the heat generating module 100.

In addition, for sliding engagement with the heat generating module 100, a groove may be formed in the support member 600. Here, the groove may guide engagement between the heat generating module 100 and the support member 600.

In addition, a hole may be formed in either of the first support member 600a and the second support member 600b. Here, the hole may be formed to apply power to the overheat protection means 300.

The cover 700 may prevent the heat generating unit 200 from coming into direct contact with a human body or an object.

The cover 700 may be disposed to cover one side of the heat generating module 100. As shown in FIG. 6, the cover 700 may be disposed on a lower side, which is one side of the heat generating module 100, and may be combined with the housing 500 to prevent separation of the heat generating module 100. For example, the cover 700 may be coupled to the housing 500 using a hook coupled to a projection formed on a side surface of the housing 500.

In addition, the cover 700 may be formed with a plurality of holes to discharge air. Here, the hole of the cover 700 may be formed in various shapes in consideration of air conditioning quality and the like.

The sensor 800 may detect the approach of a human body or an object to the heat generating module 100. Accordingly, the sensor 800 may transmit a signal for cutting off power applied to the heat generating module. Further, the controller may cut off power applied to the heat generating unit 200 to emit the heat based on the signal. Alternatively, the controller may implement sound, light, etc. for recognizing the approach based on the signal. Therefore, the sensor 800 may be provided as one of the safety devices.

Here, the sensor 800 may be a sensor that detects the capacitance of a human body or an object.

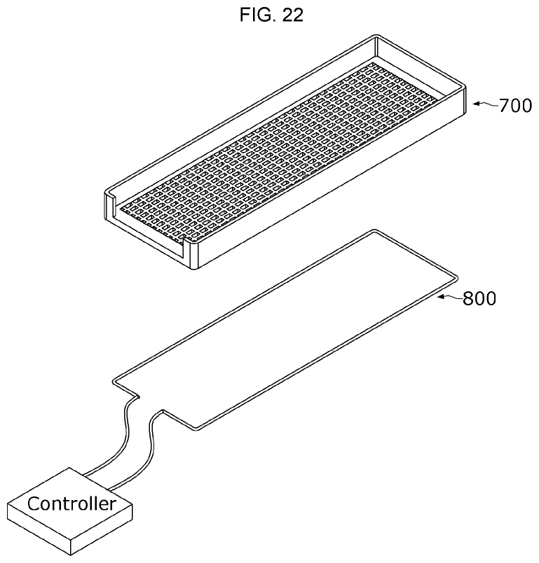

FIG. 22 is a view showing one embodiment of a sensor of a vehicle heating device according to an embodiment.

Referring to FIG. 22, the sensor 800 may be a sensing line for sensing capacitance. In addition, the sensor 800 may be electrically connected to the controller. Accordingly, when the sensor 800 detects the approach of a human body, the controller may cut off power applied to the heat generating unit 200 to emit heat.

The sensor 800 may be disposed on one side of the cover 700. For example, the sensor 800 may be disposed along the edge of the cover 700. Accordingly, the sensor 800 may effectively detect the approach of the passenger.

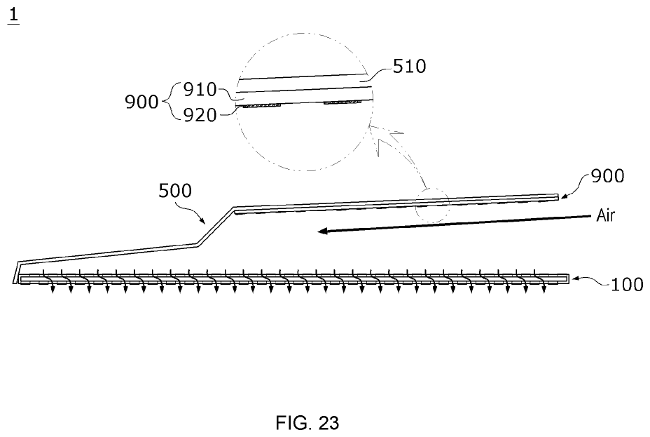

FIG. 23 is a view showing a heating part of a vehicle heating device according to an embodiment.

Referring to FIG. 23, the

vehicle heating device 1 may further include a heating part 900.

The heating part 900 may be disposed on one surface of the inner side of the duct part 510 to heat air moving along the inside of the duct part 510. Accordingly, the heating part 900 may serve as an auxiliary heater, and further minimize the heat loss through the floor duct 15 by further lowering the temperature of the air heated by the heater 13. Furthermore, by reducing the size of the heater 13 using the heating part 900, the size of the air conditioning unit 10 in which the heater 13 is disposed may also be reduced. Therefore, by using the heating part 900, the vehicle heating device 1 may improve the degree of freedom in designing the interior of the vehicle.

In addition, the heating part 900 may include a base 910 disposed on one surface of the inner side of the duct part 510 and a heat generating part 920 disposed on the base 910. The heat generating part 920 may receive power from an electrode or the like, and the power may be controlled by a controller. Accordingly, the vehicle heating device 1 may improve the heating capability by the heating part 900.

Meanwhile, the heating part 900 may be disposed on the duct part 510 by using an adhesive member (not shown). Alternatively, the heating part 900 may be formed by a method of molding a heat generating part 920 and an electrode electrically connected to the heat generating part 920 on one surface of the inner side of the duct part 510.

In addition, the heating part 900 may be electrically connected to the controller and controlled by the controller.

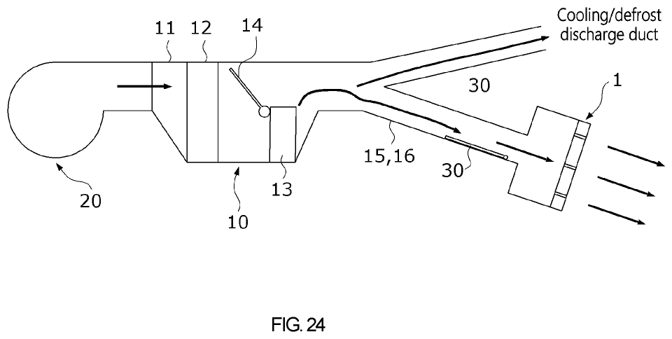

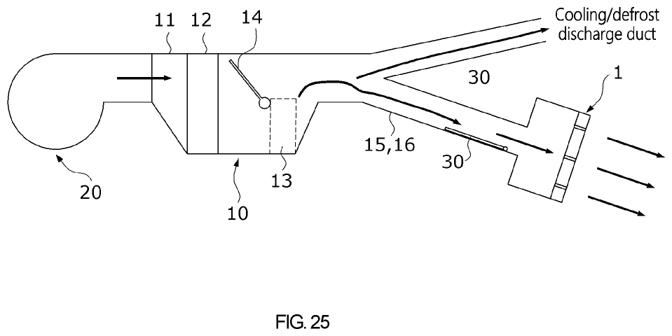

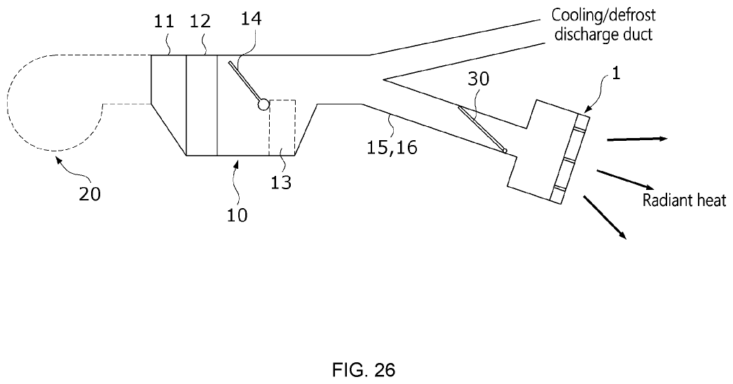

FIGS. 24 to 26 are views showing operation control of a vehicle heating device according to an embodiment, in which FIG. 24 is a view showing a maximum heating mode of the vehicle heating device according to the embodiment, FIG. 25 is a view showing a mild heating mode of the vehicle heating device according to the embodiment, and FIG. 26 is a view showing a radiation mode of the vehicle heating device according to the embodiment.

Referring to FIG. 24, when a heater 13 of an air conditioning unit 10, a blower unit 20, and a heat generating module 100 of the vehicle heating device 1 are turned on, the air supplied by the blower unit 20 may be heated. In this case, a door 30 disposed the floor duct 15 is in an open state. Here, the “on state” may mean a state in which power is applied to each component and operated. In addition, the heater 13 of the air conditioning unit 10, the blower unit 20, the door 30, and the heat generating module 100 of the vehicle heating device 1 may be controlled by the controller.

For example, the air supplied to the inside of the air conditioning unit 10 by the blower unit 20 may be firstly heated by the heater 13, and then may be secondarily heated in the vehicle heating device 1 to be discharged into the interior of the vehicle. Accordingly, in the maximum heating mode of the vehicle heating device 1, the interior of the vehicle may be heated to the maximum. The operating condition of the maximum heating mode may be when an exterior temperature of the vehicle is 20 degrees below zero or until an interior temperature of the vehicle reaches 15 degrees above zero.

Referring to FIG. 25, the blower unit 20 and the heat generating module 100 of the vehicle heating device 1 may heat the air supplied by the blower unit 20 in an ON state. In this case, the heater 13 of the air conditioning unit 10 is in an OFF state, and the door 30 disposed on the floor duct 15 is in an OPEN state. Here, the OFF state may refer to a state in which the power is cut off in order not to be operated.

For example, air may be supplied to the vehicle heating device 1 through the inside of the air conditioning unit 10 and the floor duct 15 by the blower unit 20. In addition, the air may be heated in the vehicle heating device 1 and discharged into the interior of the vehicle. Accordingly, in the mild heating mode of the vehicle heating device 1, the interior of the vehicle may be heated. The operating condition of the mild heating mode may be when the exterior temperature of the vehicle is within a range of 5 to 10 degrees below zero or until the interior temperature of the vehicle reaches 15 degrees above zero after the maximum heating mode.

Referring to FIG. 26, the heat generating module 100 of the vehicle heating device 1 may perform heating through radiant heat in an ON state. In this case, the heater 13 of the air conditioning unit 10 and the blower unit 20 are in an OFF state, and the door 30 disposed on the floor duct 15 is in a closed state.

For example, since the blower unit 20 is not operated and the door 30 is in a closed state, air supply to the vehicle heating device 1 may be cut off. Accordingly, in the radiation heating mode of the vehicle heating device 1, the interior of the vehicle may be heated only by the vehicle heating device 1. The driving state of the radiation mode may be controlled by a cold start of the vehicle, an initial cryogenic temperature of 20 degrees below zero or less, when the interior temperature of the vehicle reaches a preset temperature, or by a passenger's selection.

Furthermore, in the radiation heating mode of the vehicle heating device 1, even if the supply of air to the heat generating module 100 is cut off and the temperature of the heat generating module 100 rises, the vehicle heating device 1 may prevent the heat generating module 100 from overheating by using the overheat protection means 300.

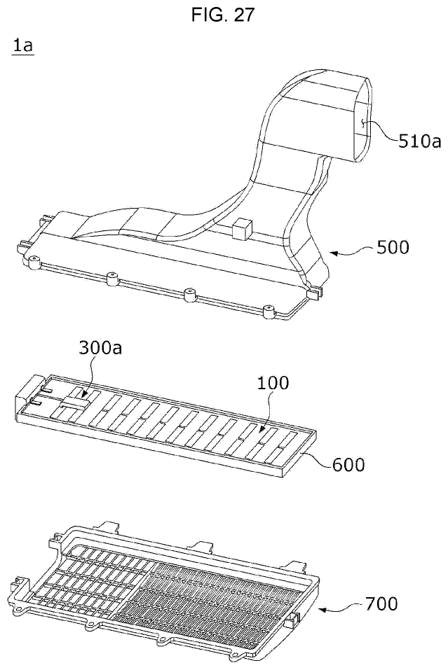

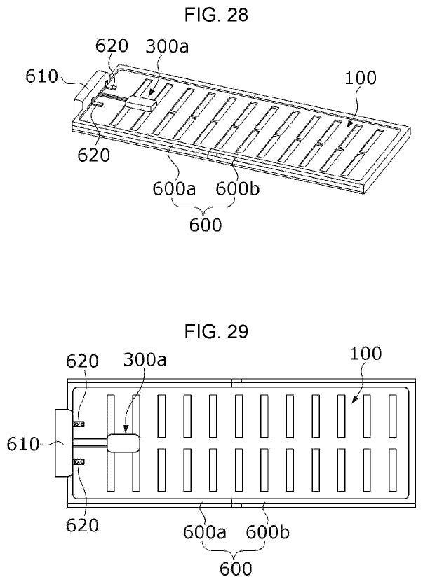

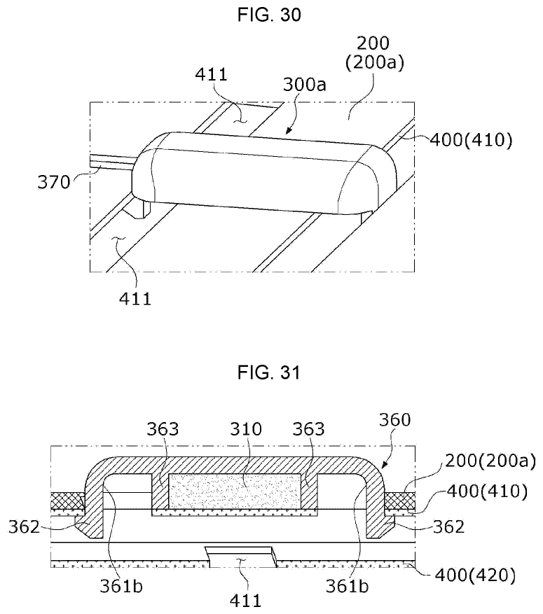

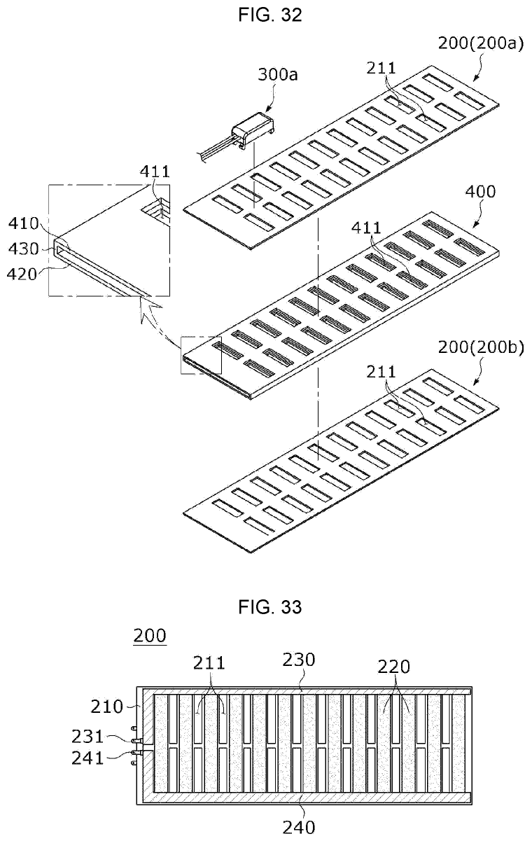

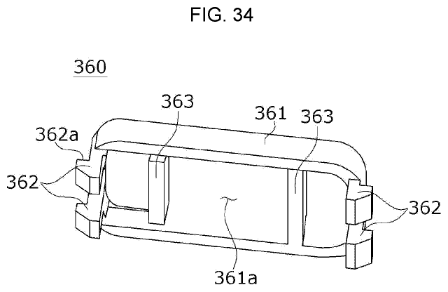

FIG. 27 is an exploded perspective view showing a modified example of an overheat protection means disposed in a vehicle heating device according to an embodiment, FIG. 28 is a perspective view showing an arrangement relationship of a heat generating module, a modified example of an overheat protection means, a support member, and a cover disposed in a vehicle heating device according to an embodiment, FIG. 29 is a plan view showing an arrangement relationship of a heat generating module, a modified example of an overheat protection means, a support member, and a cover disposed in a vehicle heating device according to an embodiment, FIG. 30 is an enlarged view of the overheat protection means shown in FIG. 28, FIG. 31 is an enlarged view of a cross section of the overheat protection means shown in FIG. 28, FIG. 32 is a view showing an arrangement relationship of a modified example of an overheat protection means, a heat generating unit, and of a frame of a vehicle heating device according to an embodiment, FIG. 33 is a view showing a heat generating unit of a vehicle heating device according to an embodiment; and FIG. 34 is a bottom perspective view showing a modified example of a case of an overheat protection means disposed in a vehicle heating device according to an embodiment.

When comparing the vehicle heating device 1 shown in FIG. 6 and the vehicle heating device 1a shown in FIG. 27, there is a difference in the position of the overheat protection means, the arrangement relationship according to the position, the structure, and the like. In this case, the vehicle heating device 1 shown in FIG. 6 may be referred to as a vehicle heating device according to a first embodiment, and the vehicle heating device 1a shown in FIG. 27 may be referred to as a vehicle heating device according to a second embodiment or a modified example of the vehicle heating device.

That is, the overheat protection means 300 of the vehicle heating device 1 according to the first embodiment and the overheat protection means 300a of the vehicle heating device 1a according to the second embodiment are different in the position, an arrangement relationship according to the position, the structure, and the like. In addition, the vehicle heating device 1a according to the second embodiment may be connected to one side of the air conditioning unit 10 instead of the vehicle heating device 1 according to the first embodiment.

In describing the vehicle heating device 1a according to the second embodiment, the same components as those of the vehicle heating device 1 according to the first embodiment are denoted by the same reference numerals, and detailed description thereof will be omitted.

Referring to FIGS. 27 to 31, the vehicle heating device 1a according to the second embodiment may include a housing 500 in which the heat generating module 100 is disposed, a support member 600 for supporting the heat generating module 100 such that the heat generating module 100 is disposed in the housing 500, and a cover 700. In addition, the vehicle heating device 1a may further include the sensor 800. In this case, the cover of the vehicle heating device 1a may have a difference in shape from the cover of the vehicle heating device (1), but the heat generating unit 200 may perform the same role as the cover in that all of the covers include holes provided for discharging air, and preventing the heat generating unit 200 from coming into direct contact with the a human body or an object.

In addition, the heat generating module 100 of the vehicle heating device 1a may include a heat generating unit 200, an overheat protection means 300a for preventing the heat generating unit 200 from overheating to a predetermined temperature, and a frame 400 for supporting the heat generating unit and the overheat protection means 300.

Referring to FIGS. 32 and 33, the heat generating unit 200 may include a planar body 210 in which a plurality of holes 211 are formed, a heat generating part 220 mounted on the body 210, and a first electrode 230 and a second electrode 240 disposed on the body 210 for applying power to the heat generating part 220. Here, the hole 211 of the body 210 may be disposed to correspond to the hole 411 of the frame 400.

In addition, for electrical connection with a connector (not shown) for applying an external power, the first electrode 230 may include a first terminal 231 disposed on one side thereof, and the second electrode 240 may include a second terminal 241 disposed on one side thereof. Here, the first terminal 231 may be referred to as a first electrode terminal. The second terminal 241 may also be referred to as a second electrode terminal.

Meanwhile, the heat generating unit 200 may be formed in two layers by being disposed to be spaced apart from each other in the air flow direction or in the vertical direction, and may be divided into an upper heat generating unit 200a and a lower heat generating unit 200b depending on the arrangement position.

In this case, the upper heat generating unit 200a may be disposed on an upper portion of the upper plate 410 in which a plurality of holes 411 are formed, and the lower heat generating unit 200b may be disposed to be spaced apart from the upper plate 410 and may be disposed on a lower portion of the lower plate 420 in which a plurality of holes 411 are formed. Here, the upper plate 410 and the lower plate 420 may be connected by a side wall 430.

The overheat protection unit 300a may detect overheating of the heat generating unit 200. Specifically, the overheat protection means 300a may prevent the heat generating unit 200 from overheating to a predetermined temperature or higher.

In addition, the overheat protection means 300a may be disposed in contact with the heat generating unit 200 and may be electrically connected in series with the heat generating unit 200 (see FIG. 10). Accordingly, the overheat protection means 300a may prevent overheating of the heat generating units 200 connected in series.

In addition, the heat generating unit 200 and the overheat protection means 300 may be connected in parallel between the relay R and the ground G. In this case, the relay R may include a coil terminal C and a switch S. Preferably, the overheat protection means 300 may be connected in series between the coil terminal C and the ground G, and the heat generating unit 200 may be connected in series between the switch S and the ground G (see FIG. 12). Accordingly, in case of abnormal overheating operation of the heat generating unit 200, the current applied to the coil terminal C may be limited by the resistance increase of the overheat protection means 300a, so that the current applied to the heat generating unit 200 by the switch S may be blocked.

Referring to FIGS. 30, 31, and 34, the overheat protection means 300a may include a heat generating element 310 having the PTC characteristic, a case 360 for tightly fixing the heat generating element 310 to the heat generating unit 200 by a hook coupling, and a wiring 370 connected to one side of the heat generating element 310.

In this case, the position, structure, etc. of the overheat protection means 300a may be determined taking into account the assembly of the overheat protection means 300a, the adhesion to the heat generating unit 200, and the sensitivity to overheating.

The heat generating element 310 may be electrically connected to a power supply through a wiring 370. In this case, the heat generating element 310 may be connected in series with the heat generating unit 200. Here, the wiring 370 may be provided as an electrical wire.

In addition, the heat generating element 310 may be disposed in contact with the heat generating unit 200. For example, the heat generating element 310 is disposed in contact with the upper heat generating unit 200a, and the temperature of the heat generating element 310 may be increased according to the temperature of the upper heat generating unit 200a.

Therefore, the heat generating element 310 may suppress overheating of the heat generating unit 200 through the above-described PCT characteristics and the series connection with the heat generating unit 200.

The case 360 may adhere the heat generating element 310 to the heat generating unit 200 by being coupled to the frame 400. In this case, the case 360 may be formed of a synthetic resin material such as plastic to improve the temperature sensitivity of the heat generating unit 200 by minimizing the influence of external heat.

Referring to FIGS. 31 and 34, the case 360 may include a case body 361 having a space therein, i.e., a cavity 361a, and a hook 362 formed to protrude from the case body 361.

In addition, the case 360 may include a partition wall 363 for isolating the heat generating element 310 disposed in the cavity 361a from an external environment. Here, the case body 361, the hook 362, and the partition wall 363 may be integrally formed.

The case body 361 may be formed in a cylindrical shape to accommodate the heat generating element 310 therein. Accordingly, the case body 361 may include the cavity 361a in which the heat generating element 310 is disposed, and the size of the cavity 361a may be adjusted by the position of the partition wall 363.

Further, an opening may be formed at one side of the case body 361 in consideration of contact between the heat generating unit 200 and the heat generating element 310.

The hook 362 may protrude from one side of the case body 361 towards the hole 411 of the frame 400.

Further, the hook 362 is passed through the hole 211 of the upper heat generating unit 200a and the hole 411 of the frame, and then may be fixed to the frame 400 using the hook 362a.

Therefore, the heat generating element 310 may be tightly fixed to the heat generating unit 200 by hook-coupling of the hook 362 and the frame 400.

The partition wall 363 may be disposed on the case body 361 to support the heat generating element 310 and at the same time minimize the influence of the external environment. In this case, the partition wall 363 may be disposed to be spaced apart from the inner surface 361b of the case body 361. Accordingly, an air gap may be formed between the inner surface 361b of the case body 361 and the partition wall 363. Therefore, the air gap may further minimize the influence of the heat generating element 310 from the external environment.

The support member 600 may include a first support member 600a and a second support member 600b.

Further, the support member 600 may include a connector part 610 and a power terminal 620 formed for coupling and electrical connection with an external power source. In this case, the connector part 610 and the power terminal 620 may be disposed farther from an inlet 510a of the housing 500 in order to provide an optimized arrangement position of the overheat protection means 300a. As shown in FIGS. 28 and 29, the connector part 610 may be formed on one side of the body of the support member which surrounds and supports one side of the heat generating module 100, and the power terminal 620 may be disposed adjacent to the connector part 610.

Referring to FIGS. 27 to 32, the overheat protection means 300a may be disposed on an upper portion of the heat generating module 100. In this case, the overheat protection means 300a may be hook-coupled to the hole 411 of the frame 400 and adhered to the upper heat generating unit 200a.

Accordingly, unlike the overheat protection means 300 of the vehicle heating device 1 according to the first embodiment, the overheat protection means 300a is disposed on the outside of the heat generating module 100 and uses a hook-coupling, so that the assembly characteristics may be improved.

In addition, the overheat protection means 300a may be disposed on the upper portion of the heat generating module 100, but on the inside of the housing 500. Accordingly, the overheat protection means 300a reacts mainly to the air moving along the inside of the housing 500 and the heat generated by the heat generating unit 200 in a state where the influence of the external heat is minimized.

Furthermore, since the air generated from the heat generating module 100 rises when the overheating occurs, the overheat protection means 300a disposed on the upper portion of the heat generating module 100 may more easily respond to this rising air.

In addition, the overheat protection means 300a may be disposed farther from the inlet 510a of the housing 500. For example, in the inside of the housing 500, since the wind volume and speed of air decrease as the distance from the inlet 510a increases, the possibility of overheating of the heat generating unit 200 is high. Accordingly, the vehicle heating device 1a may more easily respond to the overheating by disposing the overheat protection means 300a farther from the inlet 510a. Here, the inlet 510a is an area communicating with one side of the air conditioning unit 10, such that air may be introduced into the housing 500 through the inlet 510a.

Furthermore, since the overheat protection means 300a is disposed in direct and close contact with the upper heat generating unit 200a, which is excluded from contact with the outside by the frame 400, housing 500 or the like, it is possible to easily respond to overheating of the upper heat generating unit 200a, which has a relatively high probability of overheating.

Meanwhile, the overheat protection means 300a may be disposed adjacent to the power terminal 620. Accordingly, since the length of the wiring 370 is relatively short, the resistance of the wiring 370 may be reduced. Therefore, the overheat protection means 300a may improve the determination and sensitivity to overheating.

To this end, the hook 362 of the overheat protection means 300a may be coupled to a hole 411 closest to the power terminal 620 among a plurality of holes 411 formed in the frame 400. Accordingly, a distance from the power terminal 620 to the overheat protection means 300a may be much smaller than a distance from the power terminal 620 to the inlet 510a.

While the present invention has been described above with reference to exemplary embodiments, it may be understood by those skilled in the art that various modifications and changes of the present invention may be made within a range not departing from the spirit and scope of the present invention defined by the appended claims. In addition, it should be interpreted that differences related to modifications and changes fall within the scope of the present invention defined by the appended claims.

### EXPLANATION OF REFERENCE NUMERALS

1, 1a: vehicle heating device, 10: air conditioning unit, 15: floor duct, 20: blower unit, 30: door, 100: heat generating module, 200: heat generating unit, 210: body, 211: hole, 220: heat generating part, 230: first electrode, 240: second electrode, 300, 300a: overheat protection means, 362: hook, 400: frame, 500: housing, 600: support member, 700: cover, 800: sensor, 900: heating part

1-22. (canceled)

23. A vehicle heating device comprising:
a heat generating module disposed toward a passenger on an air flow channel connected to an air conditioning unit to emit heat,
wherein the heat generating module includes a heat generating unit; and an overheat protection means configured to prevent the heat generating unit from overheating to a predetermined temperature or higher, and
wherein the heat generating unit is configured to heat the interior of the vehicle through at least one of heat convection formed by heating the air and heat radiation obtained by radiating heat directly toward the passenger.

24. The vehicle heating device according to claim 23, wherein the heat generating unit is disposed in contact with the overheat protection means.

25. The vehicle heating device according to claim 23, further comprising a relay electrically connected to the heat generating unit and the overheat protection means,
wherein the relay cuts off power applied to the heat generating unit in conjunction with the temperature of the overheat protection means disposed in contact with the heat generating unit.

26. The vehicle heating device according to claim 25, wherein the heat generating module further includes a frame configured to support the heat generating unit and the overheat protection means,
wherein the heat generating unit is disposed on the frame,
the overheat protection means is disposed inside the frame, and
the heat from the heat generating unit is transferred to the overheat protection means via the frame.

27. The vehicle heating device according to claim 26, wherein the frame includes: an upper plate in which a plurality of holes are formed, a lower plate disposed spaced apart from the upper plate and having a plurality of holes formed therein; and at least one rib disposed between the upper plate and the lower plate, and
wherein the rib supports the upper plate and the lower plate while guiding air passing through the frame.

28. The vehicle heating device according to claim 23, wherein the heat generating unit includes a planar upper heat generating unit and a planar lower heat generating unit which are disposed in the frame of the heat generating module to be spaced apart from each other so as to form a heat exchange area, and
wherein the heat emitted from each of the upper heat generating unit and the lower heat generating unit is heat-exchanged with air passing through the heat generating unit in the heat exchange area.

29. The vehicle heating device according to claim 28, wherein a plurality of heat exchange areas are formed,
wherein the heat exchange area includes: a first heat exchange area formed in front of the upper heat generating unit based on the air flow direction; and a second heat exchange area formed between the upper heat generating unit and the lower heat generating unit, and
wherein the air passing through the hole of the upper heat generating unit is mixed in the second heat exchange area and simultaneously heat-exchanged with radiant heat of the upper heat generating unit and the lower heat generating unit before passing through the hole of the lower heat generating unit.

30. The vehicle heating device according to claim 29, wherein each of the upper heat generating unit and the lower heat generating unit includes: a planar body in which a hole is formed, a heat generating part disposed on the body; and a first electrode and a second electrode disposed on the body to apply power to the heat generating part, and
wherein the heat generating part of the lower heat generating unit is disposed to be overlapped with the hole of the upper heat generating unit based on the air flow direction.

31. The vehicle heating device according to claim 30, wherein the upper heat generating unit and the lower heat generating unit are selectively applied with power by a controller.

32. The vehicle heating device according to claim 23, further comprising a housing rotatably connected to a discharge duct of the air conditioning unit,
wherein the heat generating module is disposed inside the housing.

33. The vehicle heating device according to claim 32, wherein the housing includes: a duct unit connected in communication with the discharge duct; and a guide configured to guide air introduced into the duct unit to the heat generating module;
wherein the guide includes: a body in which a first guide hole and a second guide hole having different sizes are formed; and a guide projection formed to protrude from the body to guide air discharged through the first guide holes; and
wherein the second guide hole is disposed closer to the air conditioning case of the air conditioning unit than the first guide hole.

34. The vehicle heating device according to claim 23, further comprising a sensor configured to detect that a part of the passenger's body approaches the heat generating module.

35. The vehicle heating device according to claim 23, wherein a door is disposed inside the floor duct of the air conditioning unit, and
the door is configured to adjust the amount of air moving along the floor duct.

36. The vehicle heating device according to claim 33, wherein the housing further includes a heating part disposed on an inner surface of the duct unit, and wherein the heating part is configured to heat the air moving along the inside of the duct unit.

37. The vehicle heating device according to claim 23, wherein the air conditioning unit includes a heat exchanger disposed therein, and
wherein the air supplied to the air conditioning unit and passing through the heat exchanger is moved to the air flow channel.

38. The vehicle heating device according to claim 25, further comprising:
a housing accommodating the heat generating module therein and communicating with one side of the air conditioning unit; and a support member configured to support the heat generating module so that the heat generating module is disposed in the housing,
wherein the heat generating module includes a frame in which the heat generating unit is disposed; and
the overheat protection means is in close contact with the heat generating unit through hook coupling with the frame.

39. The vehicle heating device according to claim 38, wherein the overheat protection means includes: a heat generating element; a case configured to tightly fix the heat generating element to the heat generating unit through hook coupling; and a wiring connected to one side of the heat generating element, and
wherein a hook of the case is inserted into the hole of the frame.

40. The vehicle heating device according to claim 39, wherein the support member includes: a connector part formed for coupling with an external power source; and a power terminal disposed adjacent to the connector part,
wherein the hook is coupled to a hole closest to the power terminal among a plurality of holes formed in the frame, and
wherein the overheat protection means is disposed adjacent to the power terminal.

41. The vehicle heating device according to claim 39, wherein the overheat protection means is disposed farther from an inlet of the housing.

42. The vehicle heating device according to claim 39, wherein the case includes a case body having a cavity in which the heat generating element is disposed, the hook formed protruding from one side of the case body, and a partition wall disposed in the cavity to support the heat generating element; and
wherein the partition wall is disposed to be spaced apart from an inner surface of the case body.
